(19) United States
(12) Patent Application Publication
(10) Pub. No.: US 2026/0238269 A1
(43) Pub. Date: Aug. 13, 2026

(54) BEAMFORMING CONFIGURATION INDICATION FOR WIRELESS NETWORK NODES AND ASSOCIATED DEVICES, SYSTEMS, AND METHODS

(71) Applicant: QUALCOMM Incorporated, San Diego, CA (US)

(72) Inventors: Akashnil ROY, Kolkata (IN); Aman Kumar SINGH, Hyderabad (IN)

(21) Appl. No.: 19/051,757

(22) Filed: Feb. 12, 2025

(51) Int. Cl. H04B 7/06; H04W 16/28

(52) U.S. Cl. CPC H04B 7/0617; H04W 16/28

(57) ABSTRACT

A method performed by a first network node comprises: receiving, from a second network node, a first control communication indicating a first beamforming configuration index; identifying, based on the first beamforming configuration index, a first beamforming configuration file from a plurality of pre-configured beamforming configuration files; updating a beamforming configuration based on the first beamforming configuration file; and transmitting, to a user equipment (UE) based on the updated beamforming configuration, a downlink communication.

### TECHNICAL FIELD

This application relates to wireless communication systems, and more particularly to wireless communication methods and systems that use control signaling between network nodes to indicate beamforming configurations.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE). Examples of such multiple-access systems include fourth generation (4G) systems such as Long-Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM).

To meet the growing demands for expanded mobile broadband connectivity, wireless communication technologies are advancing from the long term evolution (LTE) technology to a next generation new radio (NR) technology, which may be referred to as 5th Generation (5G). For example, NR is designed to provide a lower latency, a higher bandwidth or a higher throughput, and a higher reliability than LTE. NR is designed to operate over a wide array of spectrum bands, for example, from low-frequency bands below about 1 gigahertz (GHz) and mid-frequency bands from about 1 GHZ to about 6 GHz, to high-frequency bands such as millimeter wave (mmWave) bands. NR is also designed to operate across different spectrum types, from licensed spectrum to unlicensed and shared spectrum. Spectrum sharing enables operators to opportunistically aggregate spectrums to dynamically support high-bandwidth services. Spectrum sharing can extend the benefit of NR technologies to operating entities that may not have access to a licensed spectrum.

Open Radio Access Network (O-RAN) architectures represent a transformative approach to designing and implementing radio access networks by embracing interoperability, openness, and flexibility. Unlike conventional RAN architectures, which typically rely on proprietary solutions provided by a single vendor, O-RAN disaggregates the network's hardware and software components, allowing them to be sourced from multiple vendors or service providers. This approach is enabled through open interfaces and standardized protocols, which promote vendor-agnostic integration of components. The primary benefits of O-RAN architectures include reduced deployment and operational costs, increased innovation through competition among vendors, and enhanced network flexibility to support emerging use cases, such as 5G and beyond. Furthermore, O-RAN facilitates the adoption of software-driven solutions, enabling more efficient network management and rapid deployment of updates or new features, ultimately fostering a more dynamic and sustainable ecosystem for wireless communication.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

The present disclosure describes mechanisms for configuring and beamforming configurations in wireless networks. In one aspect a scheme for beamforming configuration signaling includes a first network node indicating a wireless beamforming configuration to a second network node, and the second network node updates one or more beamforming configurations based on the indication from the first network node. In one aspect, the first network node transmits a control signal to the second network node with the indication. The control signal may include information associated with one or more pre-defined or pre-configured beamforming configurations. In some aspects, the control signal indicates one or more of beamforming configuration files of a plurality of pre-defined beamforming configuration files. The second network node updates the beamforming configuration based on the indicated beamforming configuration file.

According to one aspect of the present disclosure, a method performed by a first network node comprises: receiving, from a second network node, a first control communication indicating a first beamforming configuration index; identifying, based on the first beamforming configuration index, a first beamforming configuration file from a plurality of pre-configured beamforming configuration files; updating a beamforming configuration based on the first beamforming configuration file; and transmitting, to a user equipment (UE) based on the updated beamforming configuration, a downlink communication.

According to another aspect of the present disclosure, a second network node, comprises receiving, from a third network node, a request for a first network node to update a beamforming configuration; transmitting, to the first network node based on the request, a first control communication indicating a first beamforming configuration index associated with a first pre-configured beamforming configuration file; and receiving, from the first network node, a second control communication indicating that the first network node updated a beamforming configuration based on the first beamforming configuration index.

According to another aspect of the present disclosure, a first network node comprises: one or more memory devices; and one or more processors in communication with the one or more processors, wherein the first network node is configured to: receive, from a second network node, a first control communication indicating a first beamforming configuration index; identify, based on the first beamforming configuration index, a first beamforming configuration file from a plurality of pre-configured beamforming configuration files; update a beamforming configuration based on the first beamforming configuration file; and transmit, to a user equipment (UE) based on the updated beamforming configuration, a downlink communication.

According to another aspect of the present disclosure, a second network node comprises: one or more memory devices; and one or more processors in communication with the one or more processors, wherein the second network node is configured to: receive, from a third network node, a request for a first network node to update a beamforming configuration; transmit, to the first network node based on the request, a first control communication indicating a first beamforming configuration index associated with a first pre-configured beamforming configuration file; and receive, from the first network node, a second control communication indicating that the first network node updated a beamforming configuration based on the first beamforming configuration index.

Other aspects and features of the present invention will become apparent to those of ordinary skill in the art, upon reviewing the following description of specific, exemplary aspects of the present invention in conjunction with the accompanying figures. While features of the present invention may be discussed relative to certain aspects and figures below, all aspects of the present invention can include one or more of the advantageous features discussed herein. In other words, while one or more aspects may be discussed as having certain advantageous features, one or more of such features may also be used in accordance with the various aspects of the invention discussed herein. In similar fashion, while exemplary aspects may be discussed below as device, system, or method aspects, it should be understood that such exemplary aspects can be implemented in various devices, systems, and methods.

### BRIEF DESCRIPTION OF THE DRAWINGS

FIG. 1 illustrates a wireless communication network according to one or more aspects of the present disclosure.

FIG. 2 illustrates a diagram of an example disaggregated base station architecture according to one or more aspects of the present disclosure.

FIG. 3 illustrates a wireless communication scheme between a network unit and a user equipment (UE) that includes beamforming, according to some aspects of the present disclosure.

FIG. 4 is a diagram illustrating a control message for indicating beamforming configuration files in an open radio access network (O-RAN) according to some aspects of the present disclosure.

FIG. 5 is a signaling diagram of a method for indicating beamforming configuration files in an O-RAN according to one or more aspects of the present disclosure.

FIG. 6 illustrates a block diagram of a UE according to one or more aspects of the present disclosure.

FIG. 7 illustrates a block diagram of a network unit according to one or more aspects of the present disclosure.

FIG. 8 illustrates a flow diagram of a wireless communication method according to some aspects of the present disclosure.

FIG. 9 illustrates a flow diagram of a wireless communication method according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some aspects, well-known structures and components are shown in block diagram form in order to avoid obscuring such concepts.

This disclosure relates generally to wireless communications systems, also referred to as wireless communication networks. In various aspects, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, Global System for Mobile Communications (GSM) networks, 5^{th} Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For instance, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the UMTS mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an Ultra-high density (e.g., ~1M nodes/km²), ultra-low complexity (e.g., ~10 s of bits/sec), ultra-low energy (e.g., ~10+ years of battery life), and deep coverage with the capability to reach challenging locations; (2) including mission-critical control with strong security to safeguard sensitive personal, financial, or classified information, ultra-high reliability (e.g., ~99.9999% reliability), ultra-low latency (e.g., ~1 ms), and users with wide ranges of mobility or lack thereof; and (3) with enhanced mobile broadband including extreme high capacity (e.g., ~10 Tbps/km²), extreme data rates (e.g., multi-Gbps rate, 100+ Mbps user experienced rates), and deep awareness with advanced discovery and optimizations.

The 5G NR may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For instance, in various outdoor and macro coverage deployments of less than 3 GHz FDD/TDD implementations, subcarrier spacing may occur with 15 kHz, for instance over 5, 10, 20 MHz, and the like bandwidth (BW). For other various outdoor and small cell coverage deployments of TDD greater than 3 GHz, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mmWave components at a TDD of 28 GHz, subcarrier spacing may occur with 120 kHz over a 500 MHz BW.

The scalable numerology of the 5G NR facilitates scalable TTI for diverse latency and quality of service (QoS) requirements. For instance, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink (UL)/downlink (DL) scheduling information, data, and acknowledgement in the same subframe. The self-contained integrated subframe supports communications in unlicensed or contention-based shared spectrum, adaptive UL/DL that may be flexibly configured on a per-cell basis to dynamically switch between UL and DL to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For instance, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For instance, a method may be implemented as part of a system, device, apparatus, as instructions stored on a computer readable medium for execution on a processor or computer, or a combination of two or more of the above. Furthermore, an aspect may comprise at least one element of a claim.

In communication networks, different planes are used to organize and manage the flow of information between network nodes, ensuring efficient and reliable operation. The control plane is responsible for signaling and managing the establishment, maintenance, and termination of communication sessions, as well as managing routing and resource allocation between nodes. The management plane oversees network configuration, performance monitoring, fault detection, and overall administration to ensure optimal network operation and long-term reliability. The user plane, sometimes referred to as the data plane, handles the actual transmission of user data, such as voice, video, and other application traffic, between endpoints.

Control signaling between network nodes typically occurs through control plane signaling, which includes the exchange of messages required for tasks such as handovers, session setup, and connection management. On the other hand, management plane signaling involves interactions for configuring devices, retrieving performance metrics, and managing alarms or faults. These planes and their associated signaling mechanisms operate concurrently to ensure that the network remains responsive to user demands, scalable to accommodate growth, and resilient against faults or external challenges. By maintaining a clear separation between these planes, modern communication networks can achieve greater modularity, flexibility, and ease of troubleshooting and optimization.

As explained above, Open Radio Access Network (O-RAN) architectures represent a transformative approach to designing and implementing radio access networks by embracing interoperability, openness, and flexibility. Unlike conventional RAN architectures, which typically rely on proprietary solutions provided by a single vendor, O-RAN disaggregates the network's hardware and software components, allowing them to be sourced from multiple vendors or service providers. This approach is enabled through open interfaces and standardized protocols, which promote vendor-agnostic integration of components. The primary benefits of O-RAN architectures include reduced deployment and operational costs, increased innovation through competition among vendors, and enhanced network flexibility to support emerging use cases, such as 5G and beyond. Furthermore, O-RAN facilitates the adoption of software-driven solutions, enabling more efficient network management and rapid deployment of updates or new features, ultimately fostering a more dynamic and sustainable ecosystem for wireless communication.

Within O-RAN architectures, control plane and management plane signaling facilitate communication between the disaggregated components, such as the Centralized Unit (CU), Distributed Unit (DU), and Radio Unit (RU), to provide coordination for tasks like session establishment, resource allocation, and mobility management. O-RAN utilizes standardized and open interfaces, such as the E2 and F1 interfaces, to support vendor-agnostic control signaling, thereby promoting flexibility and innovation. Similarly, management plane signaling within O-RAN is essential for overseeing the lifecycle management of these components, including configuration, performance monitoring, and fault management. Using protocols like Simple Network Management Protocol (SNMP) or specialized frameworks such as O-RAN Alliance's Service Management and Orchestration (SMO) architecture, O-RAN enables centralized or distributed network management across heterogeneous components. By leveraging open standards and separating these signaling planes, Open RAN enhances network adaptability, scalability, and the ability to rapidly integrate new features or respond to changing operational needs.

While O-RAN architectures, including disaggregated base stations, provide many advantages, some challenges remain in providing reliable, consistent service and user experience. For instance, it may be desirable, necessary, or otherwise practical to update beamforming configurations used by one or more RUs. A beamforming configuration may be specified or defined by an associated beamforming configuration file that specifies one or more parameters for a beamforming configuration. In some instances, a DU in an O-RAN may be associated with a plurality of RUs. Each RU may be configured to communicate in a plurality of frequency bands, referred to as component carriers (CCs). To update the beamforming configuration for the plurality of RUs, the DU transmits an updated beamforming configuration file to the RUs using control signaling (e.g., C-plane signaling, M-plane signaling, etc.). The parameters may include, for instance, one or more updated weights or values associated with beamforming. The DU then initiates an RU deactivation and reactivation procedure for all CCs and RUs, which can result in a significant network outage or downtime. In some cases, the downtime can be several minutes, depending on the number of CCs.

The present disclosure describes schemes, mechanisms, and methods to enhance or improve beamforming configuration updates in O-RANs using control signaling. In one aspect, a scheme for beamforming configuration signaling includes a first O-RAN node (e.g., a DU) transmitting a control signal to a second O-RAN node (e.g., an RU) that includes an index or value associated with a pre-defined beamforming configuration file. For instance, the second O-RAN node may be pre-configured with a plurality of pre-defined beamforming configuration files, where each file is associated with at least one index. In other words, the second O-RAN node previously received (e.g., from the first O-RAN node) the plurality of pre-defined beamforming configuration files, each associated with an index. In some aspects, the control signal comprises a plurality of fields, where at least one field corresponds to the beamforming configuration file index. The field may comprise a length, such as a bit length. In one example, the beamforming configuration file index field may comprise eight bits (one byte). In some aspects, the beamforming configuration file index field may be associated with an octet of the control signal. However, it will be understood that the beamforming configuration file index may be indicated in other ways, including other fields and field lengths (e.g., fewer or more bits/bytes). In some aspects, the schemes for signaling one or more pre-defined beamforming configuration files may allow the second O-RAN node (e.g., the RU) to update or implement a different beamforming configuration with less downtime, or with no downtime. For instance, the second O-RAN node may update its beamforming configuration based on the control signal without deactivating and reactivating. Thus, the RU may remain in an activated state or mode while updating its beamforming configuration.

In one aspect, the control signal comprises a control plane (C-plane) control signal for informing an RU which pre-defined beamforming configuration file the RU will use for the pre-defined beamforming procedure. The control signal may include a plurality of octets, where each octet is associated with one or more fields. The control signal may include the beamforming configuration file index field, as explained above. The control signal may further include a beamforming configuration duration field associated with a length of time for which the updated beamforming configuration will be used or applied. For instance, the duration field may indicate the length of time as a number of slots, a number of symbols, a number of frames, a number of milliseconds, etc. In an exemplary aspect, the duration field indicates a number of slots, and the field has a length of eight bits, representing 256 possible unsigned values. In some aspects, if the duration field indicates a value of “0 ,” then the second O-RAN node may apply the updated beamforming configuration indefinitely, or for an infinite duration, until instructed otherwise. If the duration field indicates a non-zero value, then the second O-RAN node may apply the updated beamforming configuration for the number of slots indicated by the non-zero value.

In another aspect, updating the beamforming configuration as explained above is further based on a second control signal indicating whether, for instance, the whether pre-defined beamforming configuration index signaling is supported or allowed. For instance, the second O-RAN node may receive the second control signal on the M-plane at some point prior to receiving the control signal on the C-plane. The second O-RAN node may be configured to identify the pre-defined beamforming configuration file index based on the second control signal indicating that such beamforming configuration file index signaling is supported.

In one aspect, the control signal may comprise a C-plane control signal associated with a section type, and a second command type. In O-RAN control signaling, section types and section command types may be used to structure and manage the transmission of control messages between an RU and a DU. Section types may define the specific categories or purposes of the control information being conveyed, such as resource allocation, beamforming, or data transmission settings. These types enable the protocol to distinguish between various functionalities and ensure that the control message is processed appropriately. Within each section type, section command types further specify the operation to be performed, such as adding, modifying, or deleting a section. For example, a section type might indicate the allocation of physical resources, while the section command type specifies whether the allocation is being established or updated. Together, section types and section command types provide a flexible and detailed framework for dynamically managing the configuration and operation of the O-RAN system, ensuring that the control signaling is both granular and adaptable to complex network scenarios.

The section type may be a section type 1 (ST1), a section type 2 (ST2), a section type 3 (ST3), a section type 4 (ST4), or any other suitable section type. In an exemplary aspect, the control signal indicating the pre-defined beamforming configuration file index may be a section type 4 (ST4) message. In another aspect, the section command type may be associated with beamforming configuration file indication as explained above. For instance, the section command type may be exclusively used for signaling pre-defined beamforming configuration file indices between O-RAN nodes.

As mentioned above, the schemes and mechanisms described in the present application may facilitate more efficient updating of beamforming configurations in O-RAN architectures. For instance, the schemes and mechanisms described herein may allow one or more RUs to update their beamforming configurations with relatively little downtime, or with no downtime. Less downtime results in more reliable, consistent connections and an improved user experience. Further, these schemes may allow for RUs to update and optimize their beamforming configurations in deployment scenarios and use cases where substantial downtime is unacceptable.

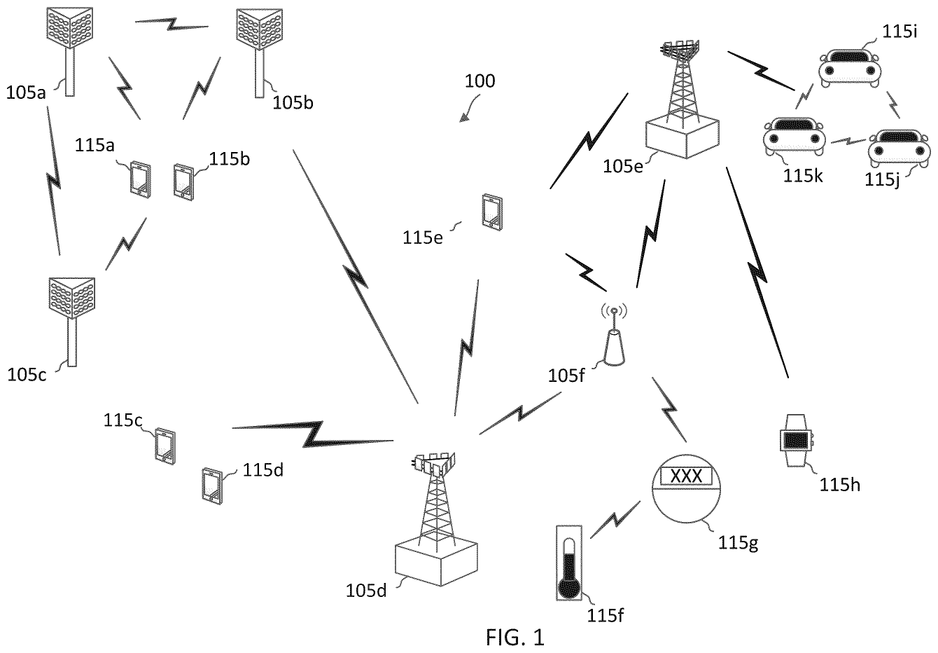

FIG. 1 illustrates a wireless communication network 100 according to one or more aspects of the present disclosure. The network 100 may be a 5G network. The network 100 includes a number of BSs 105 (individually labeled as 105a, 105b, 105c, 105d, 105e, and 105f) and other network entities. A BS 105 may be a station that communicates with UEs 115 (individually labeled as 115a, 115b, 115c, 115d, 115e, 115f, 115g, 115h, and 115k) and may also be referred to as an evolved node B (eNB), a 300 next generation eNB (gNB), an access point, and the like. Each BS 105 may provide communication coverage for a particular geographic area. In 3GPP, the term “cell” can refer to this particular geographic coverage area of a BS 105 or a BS subsystem serving the coverage area, depending on the context in which the term is used.

A BS 105 may provide communication coverage for a macro cell or a small cell, such as a pico cell or a femto cell, or other types of cells or a combination thereof. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

In some aspects, the term “base station” (e.g., the base station 105) or “network entity” may refer to an aggregated base station, a disaggregated base station, an integrated access and backhaul (IAB) node, a relay node, or one or more components thereof. For example, in some aspects, “base station” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. A “network entity” may also be referred to as a “network unit.” In some aspects, the term “base station” or “network entity” may refer to one device configured to perform one or more functions, such as those described herein in connection with the base stations 105. In some aspects, the term “base station” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station” or “network entity” may refer to any one or more of those different devices. In some aspects, the term “base station” or “network entity” may refer to one or more virtual base stations or one or more virtual base station functions. For example, in some aspects, two or more base station functions may be instantiated on a single device. In some aspects, the term “base station” or “network entity” may refer to one of the base station functions and not another. In this way, a single device may include more than one base station.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are instances of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115h are instances of various machines configured for communication that access the network 100. The UEs 115i-115k are instances of vehicles equipped with wireless communication devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the DL, UL, or both, desired transmission between BSs 105, backhaul transmissions between BSs, or sidelink transmissions between UEs 115.

In operation, the BSs 105 a-105c may serve the UEs 115 a and 115 b using 3D beamforming and coordinated spatial techniques, such as coordinated multipoint (CoMP) or multi-connectivity. The macro BS 105d may perform backhaul communications with the BSs 105a-105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an instance of a gNB or an access node controller (ANC)) may interface with the core network through backhaul links (e.g., NG-C, NG-U, etc.) and may perform radio configuration and scheduling for communication with the UEs 115. In various cases, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e. Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-action-size configurations by communicating with another user device which relays its information to the network, such as the UE 115f communicating temperature measurement information to the smart meter, the UE 115g, which is then reported to the network through the small cell BS 105f. The network 100 may also provide additional network efficiency through dynamic, low-latency TDD/FDD communications, such as V2V, V2X, C-V2X communications between a UE 115i, 115j, or 115k and other UEs 115, vehicle-to-infrastructure (V2I) communications between a UE 115i, 115j, or 115k and a BS 105, or a combination thereof.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some aspects, the subcarrier spacing between adjacent subcarriers may be fixed, and the total number of subcarriers (K) may be dependent on the system BW. The system BW may also be partitioned into subbands. In other aspects, the subcarrier spacing, the duration of TTIs, or both, may be scalable.

In some aspects, the BSs 105 can assign or schedule transmission resources (e.g., in the form of time-frequency resource blocks (RB)) for DL and UL transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes or slots, for instance, about 10. Each slot may be further divided into mini-slots. In a FDD mode, simultaneous UL and DL transmissions may occur in different frequency bands. For instance, each subframe includes a UL subframe in a UL frequency band and a DL subframe in a DL frequency band. In a TDD mode, UL and DL transmissions occur at different time periods using the same frequency band. For instance, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For instance, each DL or UL subframe may have pre-defined regions for transmissions of reference signals, control information, and data. Reference signals are predetermined signals that facilitate the communications between the BSs 105 and the UEs 115. For instance, a reference signal can have a particular pilot pattern or structure, where pilot tones may span across an operational BW or frequency band, each positioned at a pre-defined time and a pre-defined frequency. For instance, a BS 105 may transmit cell specific reference signals (CRSs), channel state information-reference signals (CSI-RSs), or both, to enable a UE 115 to estimate a DL channel. Similarly, a UE 115 may transmit sounding reference signals (SRSs) to enable a BS 105 to estimate a UL channel. Control information may include resource assignments and protocol controls. Data may include protocol data, operational data, or a combination thereof. In some aspects, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for DL communication.

In some aspects, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining system information (RMSI), and other system information (OSI)) to facilitate initial network access. In some aspects, the BSs 105 may broadcast the PSS, the SSS, the MIB, or a combination thereof, in the form of synchronization signal block (SSBs) and may broadcast the RMSI, the OSI, or a combination thereof, over a physical downlink shared channel (PDSCH). The MIB may be transmitted over a physical broadcast channel (PBCH).

In some aspects, a UE 115 attempting to access the network 100 may perform an initial cell search by detecting a PSS from a BS 105. The PSS may enable synchronization of period timing and may indicate a physical layer identity value. The UE 115 may then receive an SSS. The SSS may enable radio frame synchronization, and may provide a cell identity value, which may be combined with the physical layer identity value to identify the cell. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI, OSI, or both. After decoding the MIB, the UE 115 may receive RMSI, OSI, or both. The RMSI and OSI may include radio resource control (RRC) information related to random access channel (RACH) procedures, paging, control resource set (CORESET) for physical downlink control channel (PDCCH) monitoring, physical UL control channel (PUCCH), physical UL shared channel (PUSCH), power control, and SRS.

After obtaining the MIB, the RMSI, the OSI, or a combination thereof, the UE 115 can perform a random access procedure to establish a connection with the BS 105. In some instances, the random access procedure may be a four-step random access procedure. For instance, the UE 115 may transmit a random access preamble and the BS 105 may respond with a random access response. The random access response (RAR) may include a detected random access preamble identifier (ID) corresponding to the random access preamble, timing advance (TA) information, an UL grant, a temporary cell-radio network temporary identifier (C-RNTI), a backoff indicator, or a combination thereof. Upon receiving the random access response, the UE 115 may transmit a connection request to the BS 105 and the BS 105 may respond with a connection response. The connection response may indicate a contention resolution. In some instances, the random access preamble, the RAR, the connection request, and the connection response can be referred to as message 1 (MSG1), message 2 (MSG2), message 3 (MSG3), and message 4 (MSG4), respectively. In some instances, the random access procedure may be a two-step random access procedure, where the UE 115 may transmit a random access preamble and a connection request in a single transmission and the BS 105 may respond by transmitting a random access response and a connection response in a single transmission.

After establishing a connection, the UE 115 and the BS 105 can enter a normal operation stage, where operational data may be exchanged. For instance, the BS 105 may schedule the UE 115 for UL and DL communications. The BS 105 may transmit UL and DL scheduling grants to the UE 115 via a PDCCH. The scheduling grants may be transmitted in the form of DL control information (DCI). The BS 105 may transmit a DL communication signal (e.g., carrying data) to the UE 115 via a PDSCH according to a DL scheduling grant. The UE 115 may transmit a UL communication signal to the BS 105 via a PUSCH or PUCCH according to a UL scheduling grant. The connection may be referred to as an RRC connection. When the UE 115 is actively exchanging data with the BS 105, the UE 115 is in an RRC connected state.

In some aspects, after establishing a connection with the BS 105, the UE 115 may initiate an initial network attachment procedure with the network 100. The BS 105 may coordinate with various network entities or fifth generation core (5GC) entities, such as an access and mobility function (AMF), a serving gateway (SGW), a packet data network gateway (PGW), or a combination thereof, to complete the network attachment procedure. For instance, the BS 105 may coordinate with the network entities in the 5GC to identify the UE, authenticate the UE, or authorize the UE for sending or receiving data in the network 100. In addition, the AMF may assign the UE with a group of tracking areas (TAs). Once the network attach procedure succeeds, a context is established for the UE 115 in the AMF. After a successful attach to the network, the UE 115 can move around the current TA. For tracking area update (TAU), the BS 105 may request the UE 115 to update the network 100 with the UE 115's location periodically. Alternatively, the UE 115 may only report the UE 115's location to the network 100 when entering a new TA. The TAU allows the network 100 to quickly locate the UE 115 and page the UE 115 upon receiving an incoming data packet or call for the UE 115.

In some aspects, the BS 105 may communicate with a UE 115 using HARQ techniques to improve communication reliability, for instance, to provide a URLLC service. The BS 105 may schedule a UE 115 for a PDSCH communication by transmitting a DL grant in a PDCCH. The BS 105 may transmit a DL data packet to the UE 115 according to the schedule in the PDSCH. The DL data packet may be transmitted in the form of a transport block (TB). After receiving the DL data packet, the UE 115 may transmit a feedback message for the DL data packet to the BS 105. In some instances, the UE 115 may transmit the feedback on an acknowledgment resource. The feedback may be an acknowledgement (ACK) indicating that reception of the DL data packet by the UE 115 is successful (e.g., received the DL data without error) or may be a negative-acknowledgement (NACK) indicating that reception of the DL data packet by the UE 115 is unsuccessful (e.g., including an error or failing an error correction). In some aspects, if the UE 115 receives the DL data packet successfully, the UE 115 may transmit a HARQ ACK to the BS 105. Conversely, if the UE 115 fails to receive the DL transmission successfully, the UE 115 may transmit a HARQ NACK to the BS 105. Upon receiving a HARQ NACK from the UE 115, the BS 105 may retransmit the DL data packet to the UE 115. The retransmission may include the same coded version of DL data as the initial transmission. Alternatively, the retransmission may include a different coded version of the DL data than the initial transmission. The UE 115 may apply soft combining to combine the encoded data received from the initial transmission and the retransmission for decoding. The BS 105 and the UE 115 may also apply HARQ for UL communications using substantially similar mechanisms as the DL HARQ.

In some aspects, the network 100 may operate over a system BW or a component carrier (CC) BW. The network 100 may partition the system BW into multiple BWPs (e.g., portions). A BS 105 may dynamically assign a UE 115 to operate over a certain BWP (e.g., a certain portion of the system BW). The assigned BWP may be referred to as the active BWP. The UE 115 may monitor the active BWP for signaling information from the BS 105. The BS 105 may schedule the UE 115 for UL or DL communications in the active BWP. In some aspects, a BS 105 may assign a pair of BWPs within the CC to a UE 115 for UL and DL communications. For instance, the BWP pair may include one BWP for UL communications and one BWP for DL communications.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

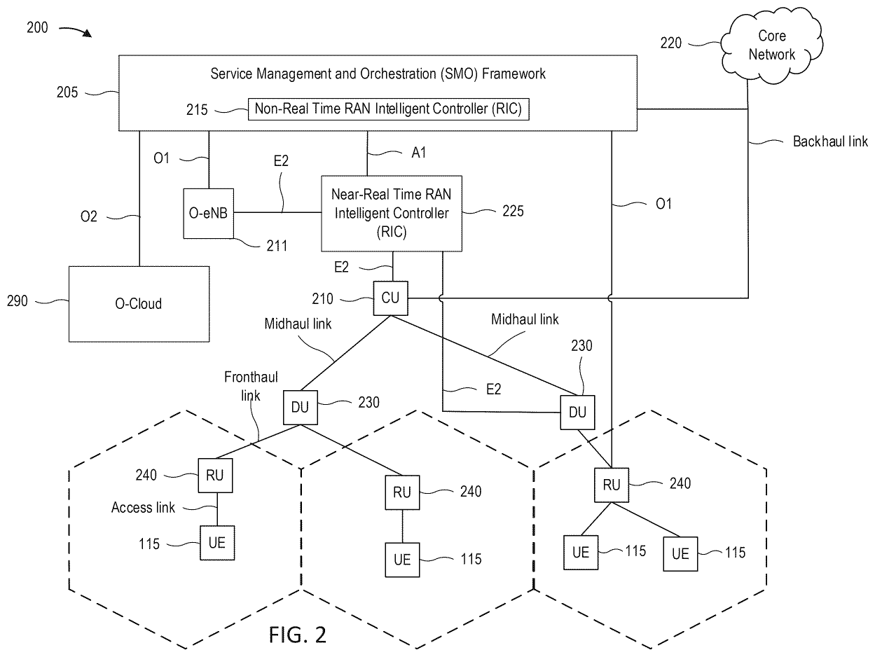

FIG. 2 shows a diagram illustrating an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 115 via one or more radio frequency (RF) access links. In some implementations, the UE 115 may be simultaneously served by multiple RUs 240.

Each of the units, i.e., the CUs 210, the DUs 230, the RUs 240, as well as the Near-RT RICs 225, the Non-RT RICs 215, and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit-User Plane (CU-UP)), control plane functionality (i.e., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communication with one or more UEs 115. In some implementations, real-time and non-real-time aspects of control and user plane communication with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

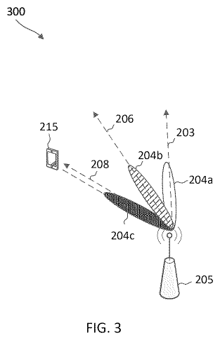

FIG. 3 illustrates a wireless communication scenario 300 using beamforming according to aspects of the present disclosure. The communication scenario 300 involves an endpoint 205 and a UE 215. In some aspects, the endpoint may be one or more of the BSs 105 of the network 100, or a network node of a disaggregated BS. For instance, the endpoint 205 may be a radio unit (RU). For simplicity, FIG. 2 illustrates one UE 215 and one endpoint 205, but a greater number of UEs 215 (e.g., about 2, 3, 4, 5, 6, 7, 8, 9, 10, or more) and/or endpoints 205 (e.g., the about 2, 3, 4 or more) may be supported. In the scenario 300, the endpoint 205 and the UE 215 communicate with each other over at least one radio frequency band. For example, the endpoint 205 may be configured to communicate with the UE 215 on one or more cells corresponding to one or more frequency bands. In some aspects, each of the one or more cells corresponds to a component carrier (CC). In other aspects, each of the one or more cells corresponds to a bandwidth part (BWP). The one or more cells may include a primary cell (PCell) or special cell (SpCell).

In some aspects, the endpoint 205 may be capable of generating a number of directional transmission beams in a number of beam or spatial directions (e.g., about 2, 4, 8, 16, 32, 64 or more) and may select a certain transmission beam or beam direction to communicate with the UE 215 based on the location of the UE 215 in relation to the location of the endpoint 205 and/or any other environmental factors such as reflectors and/or scatterers in the surrounding. For example, the endpoint 205 may select a transmission beam that provides a best quality (e.g., with the highest receive signal strength) for transmission to the UE 215. As illustrated in FIG. 3, the endpoint 205 may generate three beams 204a, 204b, and 204c. The endpoint 205 may determine that it may utilize the beam 204b or the beam 204c to communicate with the UE 215, for example, based on a beam discovery or beam selection procedure.

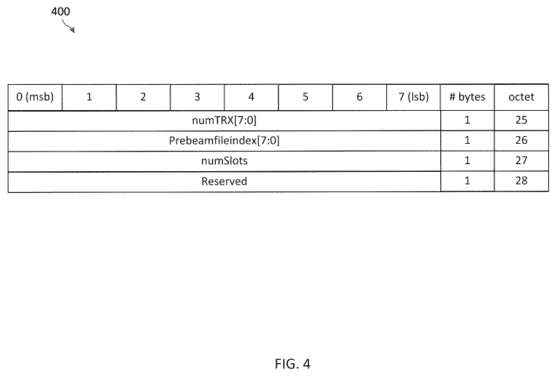

FIG. 4 is a schematic diagram of a control message for indicating one or more pre-defined beamforming configuration files between O-RAN nodes. In an exemplary aspect, the control message shown in FIG. 4 comprises a C-plane control message transmitted from a DU to an RU. However, the control message may comprise a different type of control message, such as a M-plane message, a U-plane message, or any other suitable message. In another aspect, the message may be transmitted between other O-RAN nodes, such as between a CU to the RU, from CU to DU, etc.

The control message comprises a plurality of octets. In some aspects, each octet comprises a portion of the control message that is eight bits (one byte) in length. Each octet may indicate a value. For instance, if each octet is one byte in length, then that octet may indicate a value in a range of 256 possible unsigned values (e.g., 0 to 255). In another example, one or more of the octets may indicate a signed value (e.g., −128 to 127). Each octet has a most significant bit (msb), and a least significant bit (lsb). Each octet is associated with one or more fields or parameters. In some aspects, more than one octet may be allocated to a single field or parameter. In some aspects, a single octet may be allocated to more than one field or parameter.

The control message includes a beam number field (numTRX), a beamforming configuration file index field (prebeamfileindex), and a beamforming configuration file duration field (numSlots). In the illustrated embodiment, each of these fields comprises one byte. However, it will be understood that one or more of these fields may include other bit lengths, such as 4 bits, 2 bytes, 4 bytes, etc. Further, although the beamforming configuration file duration is indicated in terms of slots (numSlots), it will be understood that the duration may be indicated in terms of symbols, frames, milliseconds, or any other suitable unit of time. Further, each octet is shown as having an octet index (e.g., 25, 26, . . . 28). However, these values are not limiting and the fields described herein may correspond to other octet indices. Further, it will be understood that the control message may have fewer or more fields than what is shown in FIG. 4.

In one aspect, the beam number field indicates the index of the beam or beams for which the beamforming configuration file index is to be applied. In other examples, the beam number field may indicate the number of beams for which the beamforming configuration file index is to be applied. Thus, in some examples, the control message may indicate a beamforming configuration file at the per-beam level. In other examples, the control message may indicate a beamforming configuration file to apply to a plurality of beams. In some cases, up to 64 beams may be used by an RU. It will be understood that the term “beam” refers to a directional transmission or reception pattern used by a wireless network node (e.g., RU, BS) to communicate with UEs using beamforming techniques. A beam can be defined by a set of configuration parameters and properties that determine its characteristics and behavior. These parameters may include the spatial direction, beam width, associated frequencies, etc. For instance, the spatial direction may be described by azimuth and elevation angles. These angles may control the beam's orientation in 3D space. The beam width may specify the angular spread of the beam for one or more angles (e.g., azimuth, elevation). The beam width may impact the focus, signal strength, and coverage area of a beam. Additionally, beams may be defined by their frequency resources (e.g., specific subcarriers or bandwidths), time resources (e.g., specific time slots), and power levels to control their reach and signal strength. Polarization, phase shifts, and weighting coefficients for antenna elements further refine the beam's shape and direction. Properties such as beam gain, sidelobe levels, and null directions may characterize the beam's effectiveness in targeting a UE while minimizing interference. Together, these parameters and properties enable precise control over beam formation, allowing the RU to maintain reliable communication with UEs in diverse directions and conditions.

In some aspects, the RU may be pre-configured or hard coded with a list of pre-defined beamforming configuration files. The beamforming configuration file index indicated by the control message indicates which beamforming configuration file in the list is to be applied, and for which beam(s). The beamforming configuration files will comprise, or be associated with, an index ranging from 0 to N-1 for N files.

As explained above, in some aspects, the RU will identify and apply the pre-defined beamforming configuration file indicated by the control message based on or in response to a M-plane control message indicating that pre-defined beamforming configuration indication is supported or allowed. Thus, in some cases, the DU will only transmit the control message indicating the pre-defined beamforming configuration file index if the DU has previously indicated that such indication us supported via M-plane control signaling.

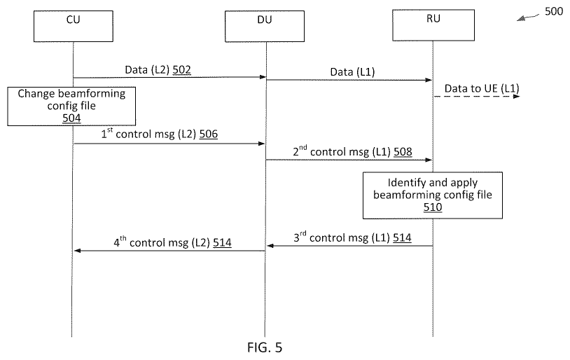

FIG. 5 is a signaling diagram of a beamforming configuration file signaling scheme 500 according to aspects of the present disclosure. The scheme 500 may be performed by a plurality of O-RAN nodes, including a DU and an RU. The scheme 500 further includes a third O-RAN node, which is a centralized unit (CU) in the illustrated example. However, it will be understood that other O-RAN architectures or variations thereof may be used, such as where the CU and the DU are integrated into a single node.

At action 502, the CU transmits data (e.g., downlink data for transmission to a UE) to the DU, which forwards the data to the RU. In some aspects, the CU transmits the downlink data using layer 2 procedures, and the DU transmits the data to the RU using layer 1 procedures.

At action 504, the CU determines to change one or more beamforming configuration files for the RU. In some aspects, the CU may determine the change the one or more beamforming configuration files for a plurality of RUs, including the RU. In some aspects, the CU determines to change the one or more beamforming configuration files for a single beam, or for a plurality of beams. For instance, the CU may determine to change one or more beamforming configuration files based on a determination to change the number of beams the RU is to use (e.g., increase or decrease). In another example, the CU may determine to change one or more beamforming configuration files based on a determination to change one or more beam weights.

At action 506, the CU transmits a control message to the DU to indicate the DU about the change in beamforming configuration files. In some aspects, the control message indicates one or more beamforming configuration file indices. In other aspects, the control message indicates one or more beamforming configuration parameters to change (e.g., number of beams, beam weights, beam widths, etc.). In some aspects, the control message transmitted at action 506 may be associated with a first section type and a first section command type.

At action 508, the DU transmits a second control message to the RU to indicate one or more beamforming configuration file indices associated with one or more beams. In some aspects, the second control message may be similar or identical to the control message 400 discussed above with respect to FIG. 4. In some aspects, the second control message transmitted at action 508 indicates a beamforming configuration file index to the RU. The file index may indicate, or otherwise be associated with, one of a plurality of pre-defined beamforming configuration files known to the RU. In one example, the second control message is a section type 4 (ST4) control message transmitted on the C-plane. In another aspect, the second control message may comprise or be associated with a section command type for indicating beamforming configuration file indices. For instance, the second control message may include a section command type 5 control message.

In another aspect, the second control message may indicate one or more beam indices, as explained above with respect to FIG. 4. In another aspect, the second control message may indicate a duration for which to apply the updated beamforming configuration indicated by the file index. In some aspects, the duration may be indicated as a number of slots. In other aspects, the duration may be indicated as a number of symbols, a number of frames, a number of milliseconds, or any other suitable unit of time.

At action 510, the RU identifies and applies, based on the beamforming configuration file index in the second control message, a beamforming configuration file from a plurality of pre-defined beamforming configuration files. In some aspects, the RU applies the indicated beamforming configuration file to the beam indicated by the beam index in the second control message. In another aspect, the RU applies the indicated beamforming configuration file to the beam, or one or more beams, for the duration of time indicated by the second control message as explained above. In some aspects, the duration of time may be indefinite or infinite.

At action 512, the RU sends a third control message to the DU. The third control message may indicate an acknowledgement or confirmation that the beamforming configuration was updated based on the beamforming configuration file indicated in the second control message. In some aspects, the third control message comprises a section type 8 (ST8) control message.

At action 514, the DU sends a fourth control message to the CU indicating the beamforming configuration file was loaded by the RU. In some aspects, the fourth control message indicates that the CU can send additional or updated beamforming configuration files. In some aspects, the method 500 further includes the CU transmitting, via layer 2, new or updated configurations to be loaded at the RU. For instance, the method may include the CU transmitting one or more additional control messages indicating one or more additional files to replace one or more files pre-defined or configured at the RU.

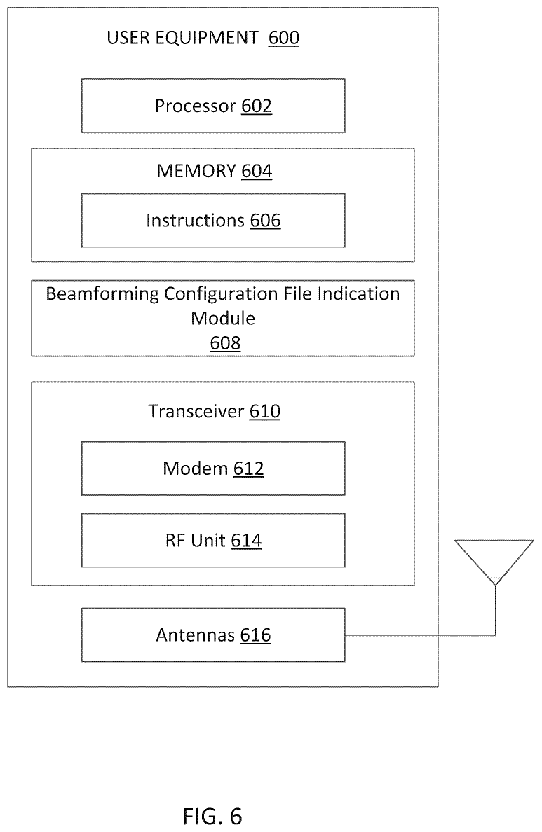

FIG. 6 is a block diagram of a UE 600 according to one or more aspects of the present disclosure. The UE 600 may be, for instance, a UE 115 as discussed in FIGS. 1 and 2. As shown, the UE 600 may include a processor 602, a memory 604, a Beamforming configuration file indication module 608, a transceiver 610 including a modem subsystem 612 and an RF unit 614, and one or more antennas 616. These elements may be coupled with one another. The term “coupled” may refer to directly or indirectly coupled or connected to one or more intervening elements. For instance, these elements may be in direct or indirect communication with each other, for instance via one or more buses.

The processor 602 may include a CPU, a DSP, an ASIC, a controller, a FPGA device, another hardware device, a firmware device, or any combination thereof configured to perform the operations described herein. The processor 602 may also be implemented as a combination of computing devices, e.g., a combination of a DSP and a microprocessor, a plurality of microprocessors, one or more microprocessors in conjunction with a DSP core, or any other such configuration.

The memory 604 may include a cache memory (e.g., a cache memory of the processor 602), RAM, MRAM, ROM, PROM, EPROM, EEPROM, flash memory, solid state memory device, hard disk drives, other forms of volatile and non-volatile memory, or a combination of different types of memory. In an aspect, the memory 604 includes a non-transitory computer-readable medium. The memory 604 may store, or have recorded thereon, instructions 606. The instructions 606 may include instructions that, when executed by the processor 602, cause the processor 602 to perform the operations described herein with reference to a UE 115 in connection with aspects of the present disclosure, for instance, aspects of FIGS. 3-6. Instructions 606 may also be referred to as program code. The program code may be for causing a wireless communication device to perform these operations, for instance by causing one or more processors (such as processor 602) to control or command the UE 600 to do so. The terms “instructions” and “code” should be interpreted broadly to include any type of computer-readable statement(s). For instance, the terms “instructions” and “code” may refer to one or more programs, routines, sub-routines, functions, procedures, etc. “Instructions” and “code” may include a single computer-readable statement or many computer-readable statements.

The Beamforming configuration file indication module 608 may be implemented via hardware, software, or combinations thereof. For instance, the Beamforming configuration file indication module 608 may be implemented as a processor, circuit, or as instructions 606 stored in the memory 604 and executed by the processor 602. In some aspects, the Beamforming configuration file indication module 608 can be integrated within the modem subsystem 612. For instance, the Beamforming configuration file indication module 608 can be implemented by a combination of software components (e.g., executed by a DSP or a general processor) and hardware components (e.g., logic gates and circuitry) within the modem subsystem 612. The Beamforming configuration file indication module 608 may communicate with one or more components of the UE 600 to implement various aspects of the present disclosure, for instance, aspects of FIGS. 3-5.

As shown, the transceiver 610 may include the modem subsystem 612 and the RF unit 614. The transceiver 610 can be configured to communicate bi-directionally with other devices, such as the BSs 105 or network units. The modem subsystem 612 may be configured to modulate and encode the data from the memory 604 or the Beamforming configuration file indication module 608 according to a MCS, e.g., a LDPC coding scheme, a turbo coding scheme, a convolutional coding scheme, a digital beamforming scheme, etc. The RF unit 614 may be configured to process (e.g., perform analog to digital conversion or digital to analog conversion, etc.) modulated/encoded data (e.g., communication signals, data signals, control signals, physical layer messages, physical layer control information transport blocks, MAC PDUs, MAC SDUs, MAC-CEs, etc.) from the modem subsystem 612 (on outbound transmissions). The RF unit 614 may be further configured to perform analog beamforming in conjunction with the digital beamforming. Although shown as integrated together in transceiver 610, the modem subsystem 612 and the RF unit 614 may be separate devices that are coupled together at the UE 600 to enable the UE 600 to communicate with other devices.

The RF unit 614 may provide the modulated and processed data, e.g., data packets (or, more generally, data messages that may contain one or more data packets and other information), to the antennas 616 for transmission to one or more other devices. The antennas 616 may further receive data messages transmitted from other devices. The antennas 616 may provide the received data messages for processing and demodulation at the transceiver 610. The transceiver 610 may provide the demodulated and decoded data (e.g., communication signals, data signals, control signals, communication signals, data signals, control signals, physical layer messages, physical layer control information transport blocks, MAC PDUs, MAC SDUs, MAC-CEs, etc.) to the Beamforming configuration file indication module 608 for processing. The antennas 616 may include multiple antennas of similar or different designs in order to sustain multiple transmission links.

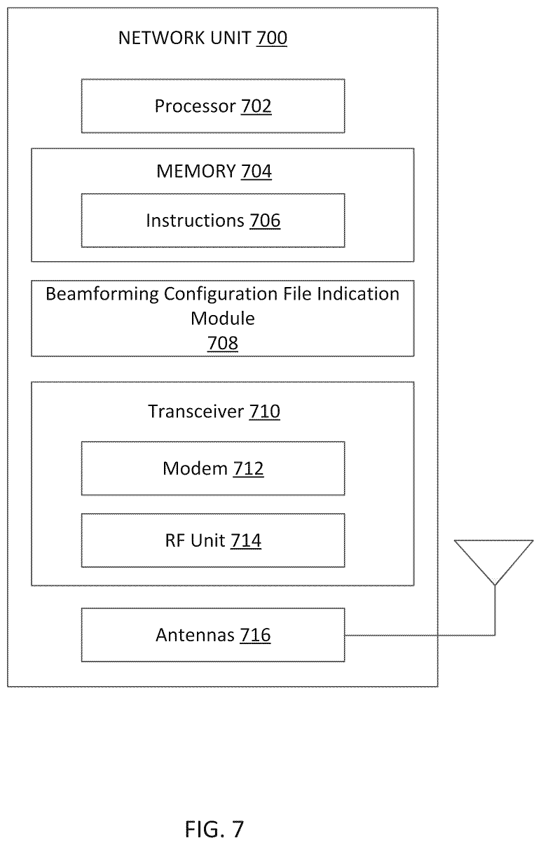

FIG. 7 is a block diagram of a network unit 700 according to one or more aspects of the present disclosure. The network unit 700 may be a BS 105, CU 210, DU 230, an RU 240, or a combination thereof, as discussed in FIGS. 1-2. The network unit 700 may include a BS. The BS may be an aggregated BS or a disaggregated BS, as described above. As shown, the network unit 700 may include a processor 702, a memory 704, a Beamforming configuration file indication module 708, a transceiver 710 including a modem subsystem 712 and a radio frequency (RF) unit 714, and one or more antennas 716. These elements may be coupled with one another. The term “coupled” may refer to directly or indirectly coupled or connected to one or more intervening elements. For instance, these elements may be in direct or indirect communication with each other, for instance via one or more buses.

The processor 702 may have various features as a specific-type processor. For instance, these may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 702 may also be implemented as a combination of computing devices, e.g., a combination of a DSP and a microprocessor, a plurality of microprocessors, one or more microprocessors in conjunction with a DSP core, or any other such configuration.

The memory 704 may include a cache memory (e.g., a cache memory of the processor 702), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, a solid state memory device, one or more hard disk drives, memristor-based arrays, other forms of volatile and non-volatile memory, or a combination of different types of memory. In some aspects, the memory 704 may include a non-transitory computer-readable medium. The memory 704 may store instructions 706. The instructions 706 may include instructions that, when executed by the processor 702, cause the network unit 700 to perform operations described herein, for instance, aspects of FIGS. 3-5. Instructions 706 may also be referred to as program code. The program code may be for causing a wireless communication device to perform these operations, for instance by causing one or more processors (such as processor 702) to control or command the network unit 700 to do so. The terms “instructions” and “code” should be interpreted broadly to include any type of computer-readable statement(s). For instance, the terms “instructions” and “code” may refer to one or more programs, routines, sub-routines, functions, procedures, etc. “Instructions” and “code” may include a single computer-readable statement or many computer-readable statements.

The Beamforming configuration file indication module 708 may be implemented via hardware, software, or combinations thereof. For instance, the Beamforming configuration file indication module 708 may be implemented as a processor, circuit, or instructions 706 stored in the memory 704 and executed by the processor 702. In some instances, the Beamforming configuration file indication module 708 can be integrated within the modem subsystem 712. For instance, the Beamforming configuration file indication module 708 can be implemented by a combination of software components (e.g., executed by a DSP or a general processor) and hardware components (e.g., logic gates and circuitry) within the modem subsystem 712. The Beamforming configuration file indication module 708 may communicate with one or more components of the network unit 700 to implement various aspects of the present disclosure, for instance, aspects of FIGS. 3-6.

In some aspects, the Beamforming configuration file indication module 708 may be configured, along with other components of the network unit 700, to communicate control signals between network nodes in an O-RAN. For instance, the Beamforming configuration file indication module 708 may be configured to transmit and receive control messages related to the indication of pre-defined beamforming configuration files, as explained above with respect to FIGS. 3-5.

As shown, the transceiver 710 may include the modem subsystem 712 and the RF unit 714. The transceiver 710 can be configured to communicate bi-directionally with other devices, such as the UE 105, UE 600, or another network unit. The modem subsystem 712 may be configured to modulate and encode data according to a modulation and coding scheme (MCS), e.g., a low-density parity check (LDPC) coding scheme, a turbo coding scheme, a convolutional coding scheme, a digital beamforming scheme, etc. The RF unit 714 may be configured to process (e.g., perform analog to digital conversion or digital to analog conversion, etc.) modulated/encoded data (e.g., communication signals, data signals, control signals, physical layer messages, physical layer control information transport blocks, MAC PDUs, MAC SDUs, MAC-CEs, etc.) from the modem subsystem 712 (on outbound transmissions). The RF unit 714 may be further configured to perform analog beamforming in conjunction with the digital beamforming. Although shown as integrated together in transceiver 710, the modem subsystem 712, or the RF unit 714 may be separate devices that are coupled together at the network unit 700 to enable the network unit 700 to communicate with other devices.

The RF unit 714 may provide the modulated and processed data, e.g., data packets (or, more generally, data messages that may contain one or more data packets and other information), to the antennas 716 for transmission to one or more other devices. The antennas 716 may further receive data messages transmitted from other devices and provide the received data messages for processing and demodulation at the transceiver 710. The transceiver 710 may provide the demodulated and decoded data (e.g., communication signals, data signals, control signals, physical layer messages, physical layer control information transport blocks, MAC PDUs, MAC SDUs, MAC-CEs, etc.) to the Beamforming configuration file indication module 708 for processing. The antennas 716 may include multiple antennas of similar or different designs in order to sustain multiple transmission links.

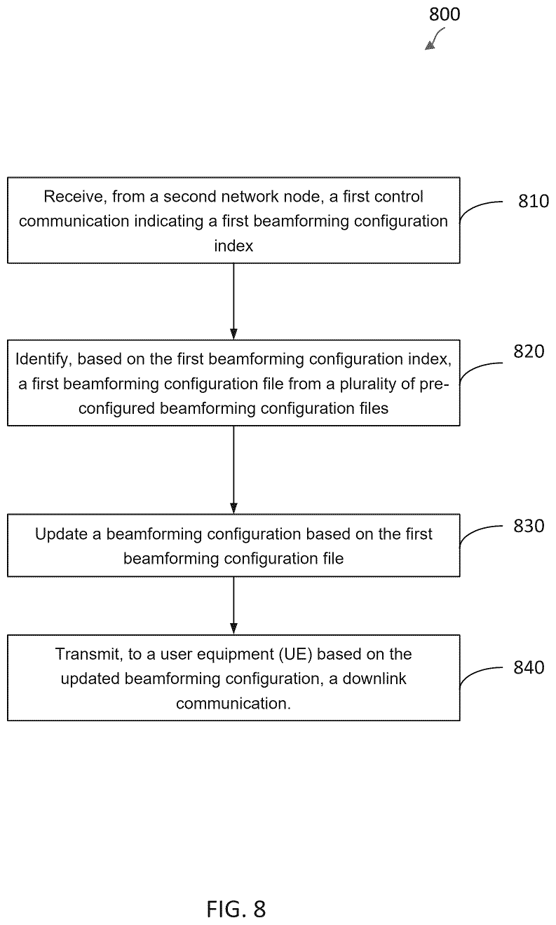

FIG. 8 is a flow diagram illustrating a wireless communication method 800 according to one or more aspects of the present disclosure. Aspects of the method 800 can be executed by a computing device (e.g., one or more processors, processing circuits, or other suitable components) of a first network node or other suitable means for performing the blocks. For instance, the first network node may be a RU. The first network node may utilize one or more components, such as the processor 702, the memory 704, the Beamforming configuration file indication module 708, the transceiver 710, the modem subsystem 712, the RF unit 714, the one or more antennas 716, or a combination thereof, to execute the blocks of method 800. The method 800 may employ similar mechanisms as described in FIGS. 3-5. As illustrated, the method 800 includes a number of enumerated blocks, but aspects of the method 800 may include additional blocks before, after, and in between the enumerated blocks. In some aspects, one or more of the enumerated blocks may be omitted or performed in a different order.

At block 810, the first network node receives, from a second network node, a first control communication. In one example, the first control communication comprises a control message associated with a section type and a section command type. In on aspect, the first control communication indicates a first beamforming configuration index. For instance, the first beamforming configuration index may comprise an index associated with a pre-defined or pre-configured beamforming configuration file. In some aspects, the index may be indicated in one or more fields of the first control communication. The one or more fields may be associated with one or more octets. In some aspects, the index may comprise an eight bit (one byte) length. In some aspects, the section type comprises a section type 4 (ST4). The section command type may be configured or specified for indicating beamforming configuration files. In some aspects the first control communication further indicates an index of one or more beams. The index of the one or more beams may indicate which beam or beams the first beam configuration index applies to.

At block 820, the first network node identifies, based on the first beamforming configuration index, a first beamforming configuration file from a plurality of pre-configured beamforming configuration files. For instance, the plurality of pre-configured beamforming configuration files may be stored in one or more memory devices of the first network node. The first beamforming configuration file may be loaded for the indicated beam or beams based on the beamforming configuration index.

At block 830, the first network node updates a beamforming configuration based on the first beamforming configuration file identified at block 820. In some aspects, the beamforming configuration file is loaded and applied at block 830 for the one or more indicated beams. Updating the beamforming configuration may comprise modifying or changing one or more weights, gains, or other parameters associated with beamforming. In some aspects, block 830 may comprise applying the first beamforming configuration file for a limited duration of time. In other aspects, block 830 comprises applying the first beamforming configuration file for an indefinite or infinite duration, until instructed to further change the beamforming configuration. \

At block 840, the first network node transmits, to a UE based on the updated beamforming configuration, a downlink communication.

It will be understood that one or more aspects of the method 800 correspond to one or more actions of the scheme 500 shown in FIG. 5.

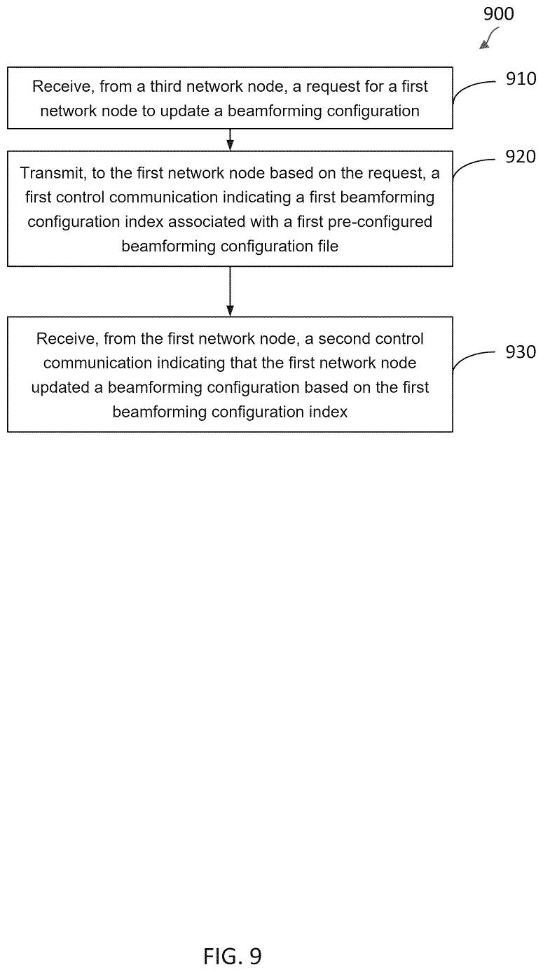

FIG. 9 is a flow diagram illustrating a wireless communication method 900 according to one or more aspects of the present disclosure. Aspects of the method 900 can be executed by a computing device (e.g., one or more processors, processing circuits, or other suitable components) of a second network node or other suitable means for performing the blocks. For instance, the second network node may be a DU. The second network node may utilize one or more components, such as the processor 702, the memory 704, the Beamforming configuration file indication module 708, the transceiver 710, the modem subsystem 712, the RF unit 714, the one or more antennas 716, or a combination thereof, to execute the blocks of method 900. The method 900 may employ similar mechanisms as described in FIGS. 3-5. As illustrated, the method 900 includes a number of enumerated blocks, but aspects of the method 900 may include additional blocks before, after, and in between the enumerated blocks. In some aspects, one or more of the enumerated blocks may be omitted or performed in a different order.

At block 910, the second network node receives, from a third network node, a request for a first network node to update a beamforming configuration. In some aspects, the third network node comprises another unit in an O-RAN, such as a CU.

At block 920, the second network node transmits, to the first network node based on the request, a first control communication. In one example, the first control communication comprises a control message associated with a section type and a section command type. In one aspect, the first control communication indicates a first beamforming configuration index. For instance, the first beamforming configuration index may comprise an index associated with a pre-defined or pre-configured beamforming configuration file. In some aspects, the index may be indicated in one or more fields of the first control communication. The one or more fields may be associated with one or more octets. In some aspects, the index may comprise an eight bit (one byte) length. In some aspects, the section type comprises a section type 4 (ST4). The section command type may be configured or specified for indicating beamforming configuration files. In some aspects the first control communication further indicates an index of one or more beams. The index of the one or more beams may indicate which beam or beams the first beam configuration index applies to.

At block 930, the second network node receives, from the first network node, a second control communication indicating that the first network node updated a beamforming configuration based on the first beamforming configuration index. The second control message may be associated with a section type and a section command type. In some aspects, the section type comprises a section type 8 (ST8). Thus, the section type of the second control communication may be different from the section type of the first control communication (e.g., ST4).

Aspects of the method 900 may include one or more actions of the scheme 500 illustrated by FIG. 5. For instance, the method 900 may include receiving, from the first network node, a further control message indicating a capability of the first network node for updating beamforming configurations based on a beamforming configuration file index. Thus, the transmitting the first control communication may be performed based on, or in response to, receiving the further control message indicating the capability.

Other aspects of the present disclosure include:

Aspect 1. A method performed by a first network node, the method comprising: receiving, from a second network node, a first control communication indicating a first beamforming configuration index; identifying, based on the first beamforming configuration index, a first beamforming configuration file from a plurality of pre-configured beamforming configuration files; updating a beamforming configuration based on the first beamforming configuration file; and transmitting, to a user equipment (UE) based on the updated beamforming configuration, a downlink communication.

Aspect 2. The method of aspect 1, wherein the first control communication comprises a section type control message including a section command type.

Aspect 3. The method of aspect 2, wherein the section type control message comprises a section type 4 (ST4) message, and wherein the section command type is a beamforming configuration file indication section command type.

Aspect 4. The method of aspect 1, wherein the first control communication comprises a control plane (C-plane) control message.

Aspect 5. The method of aspect 1, wherein the first control communication further indicates a first beam index, and wherein the updating the beamforming configuration is based on the first beam index.

Aspect 6. The method of aspect 1, wherein the first control communication further indicates a duration for updating the beamforming configuration, and wherein the updating the beamforming configuration comprises updating the beamforming configuration for the duration indicated in the first control communication.

Aspect 7. The method of aspect 6, wherein the first control communication comprises a field indicating the duration, wherein the field indicates the duration as a number of slots.

Aspect 8. The method of aspect 1, further comprising transmitting, to the second network node, an indication of a capability of the first network node, wherein the capability comprises a capability for updating the beamforming configuration based on a beamforming configuration index, wherein the receiving the first control communication is based on the indication of the capability.

Aspect 9. The method of aspect 8, wherein the indication of the capability comprises an M-plane control message.

Aspect 10. The method of aspect 1, further comprising transmitting, to the second network node, a second control communication indicating that the beamforming configuration was updated based on the first beamforming configuration index.

Aspect 11. The method of aspect 1, wherein the first network node comprises a radio unit (RU) in an open radio access network (O-RAN), and wherein the second network node comprises a distributed unit (DU) in the O-RAN.

Aspect 12. A method performed by a second network node, the method comprising: receiving, from a third network node, a request for a first network node to update a beamforming configuration; transmitting, to the first network node based on the request, a first control communication indicating a first beamforming configuration index associated with a first pre-configured beamforming configuration file; and receiving, from the first network node, a second control communication indicating that the first network node updated a beamforming configuration based on the first beamforming configuration index.

Aspect 13. The method of aspect 12, wherein the first control communication comprises a section type control message including a section command type.

Aspect 14. The method of aspect 13, wherein the section type control message comprises a section type 4 (ST4) message, and wherein the section command type is a beamforming configuration file indication section command type.

Aspect 15. The method of aspect 12, wherein the first control communication comprises a control plane (C-plane) control message.

Aspect 16. The method of aspect 12, wherein the first control communication further indicates a first beam index, and wherein the updating the beamforming configuration is based on the first beam index.

Aspect 17. The method of aspect 12, wherein the first control communication further indicates a duration for updating the beamforming configuration, and wherein the updating the beamforming configuration comprises updating the beamforming configuration for the duration indicated in the first control communication.

Aspect 18. The method of aspect 17, wherein the first control communication comprises a field indicating the duration, wherein the field indicates the duration as a number of slots.

Aspect 19. The method of aspect 12, further comprising receiving, from the first network node, an indication of a capability of the first network node, wherein the capability comprises a capability for updating the beamforming configuration based on a beamforming configuration index, wherein the transmitting the first control communication is based on the indication of the capability.

Aspect 20. The method of aspect 19, wherein the indication of the capability comprises an M-plane control message.

Aspect 21. The method of aspect 12, wherein the first network node comprises a radio unit (RU) in an open radio access network (O-RAN), wherein the second network node comprises a distributed unit (DU) in the O-RAN, and wherein the third network node comprises a centralized unit (CU) in the O-RAN.

Aspect 22. A first network node, comprising: one or more memory devices; and one or more processors in communication with the one or more processors, wherein the first network node is configured to perform the steps of any of aspects 1-11.

Aspect 23. A second network node, comprising: one or more memory devices; and one or more processors in communication with the one or more processors, wherein the second network node is configured to perform the steps of any of aspects 12-21.

Aspect 24. A non-transitory, computer-readable medium having program code recorded therein, wherein the program code comprises instructions executable by one or more processors of a first network node to cause the first network node to perform the actions of any of aspects 1-11.

Aspect 25. A non-transitory, computer-readable medium having program code recorded therein, wherein the program code comprises instructions executable by one or more processors of a second network node to cause the first network node to perform the actions of any of aspects 12-21.

Aspect 26. A first network node, comprising means for performing the steps of any of aspects 1-11.

Aspect 27. A second network node, comprising means for performing the steps of any of aspects 12-21.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other aspects and implementations are within the scope of the disclosure and appended claims. For instance, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for instance, a list of items prefaced by a phrase such as “at least one of” or “one or more of”) indicates an inclusive list such that, for instance, a list of [at least one of A, B, or C] means A or B or C or AB or AC or BC or ABC (e.g., A and B and C).

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular aspects illustrated and described herein, as they are merely by way of some aspects thereof, but rather, should be fully commensurate with that of the claims appended hereafter and their functional equivalents.

What is claimed is:

1. A first network node, comprising:
one or more memory devices; and
one or more processors in communication with the one or more processors, wherein the first network node is configured to:
receive, from a second network node, a first control communication indicating a first beamforming configuration index;
identify, based on the first beamforming configuration index, a first beamforming configuration file from a plurality of pre-configured beamforming configuration files;
update a beamforming configuration based on the first beamforming configuration file; and
transmit, to a user equipment (UE) based on the updated beamforming configuration, a downlink communication.

2. The first network node of claim 1, wherein the first control communication comprises a section type control message including a section command type.

3. The first network node of claim 2, wherein the section type control message comprises a section type 4 (ST4) message, and wherein the section command type is a beamforming configuration file indication section command type.

4. The first network node of claim 1, wherein the first control communication comprises a control plane (C-plane) control message.

5. The first network node of claim 1, wherein the first control communication further indicates a first beam index, and wherein the first network node is configured to update the beamforming configuration based on the first beam index.

6. The first network node of claim 1, wherein the first control communication further indicates a duration for updating the beamforming configuration, and wherein the first network node configured to update the beamforming configuration comprises the first network node configured to update the beamforming configuration for the duration indicated in the first control communication.

7. The first network node of claim 1, wherein the first network node is configured to transmit, to the second network node, an indication of a capability of the first network node, wherein the capability comprises a capability for updating the beamforming configuration based on a beamforming configuration index,
wherein the first network node is configured to receive the first control communication based on the indication of the capability.

8. The first network node of claim 7, wherein the indication of the capability comprises an M-plane control message.

9. The first network node of claim 1, wherein the first network node is configured to transmit, to the second network node, a second control communication indicating that the beamforming configuration was updated based on the first beamforming configuration index.

10. The first network node of claim 1, wherein the first network node comprises a radio unit (RU) in an open radio access network (O-RAN), and wherein the second network node comprises a distributed unit (DU) in the O-RAN.

11. A second network node, the method comprising:
one or more memory devices; and
one or more processors in communication with the one or more processors, wherein the second network node is configured to:
receive, from a third network node, a request for a first network node to update a beamforming configuration;
transmit, to the first network node based on the request, a first control communication indicating a first beamforming configuration index associated with a first pre-configured beamforming configuration file; and
receive, from the first network node, a second control communication indicating that the first network node updated a beamforming configuration based on the first beamforming configuration index.

12. The second network node of claim 11, wherein the first control communication comprises a section type control message including a section command type.

13. The second network node of claim 12, wherein the section type control message comprises a section type 4 (ST4) message, and wherein the section command type is a beamforming configuration file indication section command type.

14. The second network node of claim 11, wherein the first control communication comprises a control plane (C-plane) control message.

15. The second network node of claim 11, wherein the first control communication further indicates a first beam index, and wherein the beamforming configuration is updated based on the first beam index.

16. The second network node of claim 11, wherein the first control communication further indicates a duration for updating the beamforming configuration, and wherein the beamforming configuration is updated for the duration indicated in the first control communication.

17. The second network node of claim 11, further comprises the second network node configured to receive, from the first network node, an indication of a capability of the first network node, wherein the capability comprises a capability for updating the beamforming configuration based on a beamforming configuration index,
wherein the second network node is configured to transmit the first control communication based on the indication of the capability.

18. The second network node of claim 17, wherein the indication of the capability comprises an M-plane control message.

19. The second network node of claim 11, wherein the first network node comprises a radio unit (RU) in an open radio access network (O-RAN), wherein the second network node comprises a distributed unit (DU) in the O-RAN, and wherein the third network node comprises a centralized unit (CU) in the O-RAN.

20. A method performed by a first network node, the method comprising:
receiving, from a second network node, a first control communication indicating a first beamforming configuration index;
identifying, based on the first beamforming configuration index, a first beamforming configuration file from a plurality of pre-configured beamforming configuration files;
updating a beamforming configuration based on the first beamforming configuration file; and
transmitting, to a user equipment (UE) based on the updated beamforming configuration, a downlink communication.
